(19) United States
(12) Patent Application Publication
(10) Pub. No.: US 2016/0047694 A1
(43) Pub. Date: Feb. 18, 2016

(54) Line & Pipe Flexible Temperature Sensor Assembly

(71) Applicants: John Proctor, Fairfax, CA (US); Adrian Hairrell, San Francisco, CA (US); Abram Conant, San Francisco, CA (US)

(72) Inventors: John Proctor, Fairfax, CA (US); Adrian Hairrell, San Francisco, CA (US); Abram Conant, San Francisco, CA (US)

(21) Appl. No.: 14/928,792

(22) Filed: Oct. 30, 2015

Related U.S. Application Data
(63) Continuation of application No. 13/694,576, filed on Dec. 12, 2012, now abandoned.

(51) Int. Cl. G01K 1/14; G01K 13/02

(52) U.S. Cl. CPC G01K 1/143; G01K 13/02

(57) ABSTRACT

A temperature sensor assembly is disclosed, formed of flexible, resilient, and insulative material, so that a contact temperature sensor, situated in a housing and connected to an electrical meter, may be affixed temporarily or permanently to a (generally) cylindrical tube, pipe, or other “line,” the distal ends of the housing straps stretched and tensioned to press the housing and contact temperature sensor on to the exterior of such fluid line to keep the housing in the correct position on the fluid line, and the distal ends of the straps joined to secure the assembly to the fluid line, so that the temperature on the exterior of the fluid line, and the temperature of the fluid therewithin, may thereby be measured.

### CROSS-REFERENCE AND RELATED APPLICATIONS

This application is a continuation of U.S. application Ser. No. 13/694,576, filed Dec. 12, 2012, from which the applicant claims priority.

### TECHNICAL FIELD OF THE INVENTION

The present invention relates to temperature sensors, by which the temperature of an object may be measured. More specifically, the present invention consists primarily of a new design for a temperature sensor assembly (the “Assembly”) which is employed to measure the temperature of a (generally) cylindrical tube, pipe, or other “line,” within which a heating or cooling fluid flows. We refer to such tubes, pipes, or other lines individually in this application as a “Fluid Line,” and collectively as “Fluid Lines,” and temperature sensors used for measuring a Fluid Line individually as a “Sensor,” and collectively as Sensors.

Sensors are used in a variety of industrial and scientific processes and applications, but are particularly necessary to the installation and maintenance of heating, cooling, and refrigeration systems, such as environmental cooling systems (e.g., “air conditioning”). The primary purpose of such a Sensor is to read the temperature of the fluid contained within, and moving within, a Fluid Line. However, direct reading of the fluid within a Fluid Line is generally not practical, because the fluid within a Fluid Line is generally installed under pressure, in some cases high pressure. Opening a Fluid Line to insert a Sensor is therefore considered undesirable, as sealing such a Fluid Line is difficult and expensive, and may ultimately not be successful.

The accuracy of reading the temperatures of a fluid within a Fluid Line by affixing Sensor to the exterior of such a line is, however, affected by the temperature of the ambient air, water, or other fluid (collectively termed “ambient air” herein) in which the Fluid Line and the Sensor sit. For instance, a Fluid Line, formed generally of a metallic material in tubular form, is heated or cooled by such ambient air temperature on its exterior, separate from the effect of the fluid within the Fluid Line. Heat is thereby conducted within the material of the Fluid Line from areas of the Fluid Line close to the Sensor, on to the site at which the Sensor is affixed to the Fluid Line (for a Fluid Line with a cooler fluid within), or away from the Sensor to such peripheral areas (for a Fluid Line with a warmer fluid within). The difference between the temperature on the exterior of a Fluid Line, to which a Sensor is affixed, and the temperature of the fluid within that Fluid Line, makes the temperature reading of Sensor affixed to the exterior of a Fluid Line inherently inaccurate. That inaccuracy results in less than optimal installation of cooling and heating systems, and less than optimal maintenance of such systems.

Other sources of inaccuracy in reading the fluid within a Fluid Line add to such inaccuracy, thereby reducing the effectiveness of installation of a heating or cooling system, by reducing the efficiency of a system which is adjusted by reference to the (inaccurate) temperatures within such systems, and by reference to (inaccurate) temperature differences within different parts of such systems. The present invention is a device by which the inaccuracy inherent in reading the temperature of fluid within a Fluid Line is reduced. Increased accuracy of temperature readings in the present invention are achieved by changes in design and materials of manufacture away from designs and materials commonly utilized to manufacture Sensors within the field of heating and cooling systems. By reducing inaccuracy of reading the temperature of a fluid within a Fluid Line, the Assembly of the present invention allows a heating or cooling system to be “tuned” to maximize efficiency, thereby increasing the effectiveness of such systems, while reducing overall energy costs.

### BACKGROUND ART OF THE INVENTION

Accurate Fluid Line readings are necessary to provide proper controls and diagnosis in many fields. Accurately charging refrigerant based heating, cooling, and refrigeration systems (singly a “System”, and collectively “Systems”), for instance, is paramount in maximizing system efficiency. Charging these Systems for correct, even optimal, operation is heavily dependent on the line temperatures these Systems produce when they are operating. A failure to measure correct line temperature, therefore, can lead to incorrect diagnosis and adjustments that might lead to System inefficiency, and even System failure.

However, the temperatures an operator wishes to measure when installing or maintaining a System are the temperatures within the Fluid Lines of the System, or within a number of Fluid Lines within a System, rather than the temperature of the exterior of such Fluid Line or Fluid Lines. With accurate temperature readings of the fluids within a Fluid Line, an operator may calculate optimum charging temperatures for a System based on known scientific principles and manufacturers' specifications. With such calculated temperatures, an operator may then add or remove the proscribed fluid, to match the correct specifications within the System and the System Fluid Lines.

The temperatures of fluids within a Fluid Line are difficult to measure for a number of reasons, all of which result from circumstances external to the Fluid Line and the material from which the Fluid Line is formed. These inaccuracies arise whether a Sensor is designed for permanent affixation to a Fluid Line or temporary affixation to a Fluid Line.

For instance, the accuracy of reading the temperature of a fluid within a Fluid Line by affixing a Sensor to the exterior of such a line is affected by ambient air temperature directly affecting the Sensor at the site at which the Sensor is affixed to the Fluid Line. Because the electrically active temperature reading element of a Sensor is generally affixed to the exterior of a Fluid Line, that Sensor may be surrounded in part with ambient air which is warmer or cooler than the exterior of the Fluid Line (and so even warmer or cooler than the fluid within the Fluid Line). Such an externally applied Sensor is as a result affected both by the temperature of the exterior of the Fluid Line and by the temperature of such ambient air, with the further result that the Sensor then “reads” or indicates a temperature somewhere between the temperature of the exterior of the Fluid Line and such ambient air.

Further, the accuracy of reading the temperature of a fluid within a Fluid Line by affixing a Sensor to the exterior of such a line is also affected by ambient air temperature affecting the temperature of a Fluid Line near the site at which the Sensor is affixed to the Fluid Line. A Fluid Line, formed generally of a metallic material in tubular form, is heated or cooled by such ambient air temperature on its exterior, separate from the effect of the fluid within the Fluid Line, and carries that ambient air heat (or cool) to the site of the Sensor. With a metallic Fluid Line, heat is quickly and efficiently conducted within the material of the Fluid Line, from areas of the Fluid Line close (and in some cases not so close) to the Sensor, to the site at which the Sensor is affixed to the Fluid Line (for a Fluid Line with a cooler fluid within), or away from the Sensor to such areas peripheral areas (for a Fluid Line with a warmer fluid within). Again an externally applied Sensor is as a result affected by the heat transferred from other areas of the Fluid Line, and the resultant change in temperature of the material from which the Fluid Line is formed, caused by ambient air at such other areas. As a result, the Sensor then again reads the temperature of the exterior of the Fluid Line, which is some temperature between such ambient air and the temperature of the fluid within the Fluid Line.

A number of devices have been designed to address the inaccuracies which arise from these sources. These devices include those which appear in the following United States patents:
U.S. Pat. No. 5,172,979—Heater Tube Skin Thermocouple.
   The apparatus of this patent is a thermocouple designed with a “heat shield” housing, formed to be held adjacent a pipe, for measurement of the temperature of that pipe. However, the device we see in this patent is “welded to the hottest location on the tube.” Such welding both seals the Sensor within the housing, and affixes the housing to the pipe to be measured.
2. U.S. Pat. No. 5,382,093—Removable Temperature Measuring Device.
   The apparatus of this patent is a device for measuring the skin temperature of a conduit, adapted to be removably inserted within a similarly curved guide tube, with a similarly-shaped, insulated shield. Unlike the previous patent, this patent begins to address the need for applying a Sensor to a pipe or tube, taking a reading, and then removing the Sensor. In this apparatus the thermocouple is sheathed by suitable insulating material to “protect it from excessive ambient temperature.” However, this apparatus would appear to be a rigid device, formed so as to be inflexible, in an arrangement and with materials which cannot provide the accuracy of the Assembly of the present invention.
3. U.S. Pat. No. 5,454,641—Temperature Transducer Assembly.
   The apparatus of this patent is a device for sensing temperatures in a “heat pump” refrigeration system used for heating and cooling buildings, in which the Sensor of the device is affixed to the tube referred to in this patent using clips. This patent also discusses a “dead air space” created by the insulating jacket, in recognition of the sources of inaccuracy in reading a temperature noted above.
4. U.S. Pat. No. 6,546,823—Sensor Arrangement.
   The apparatus of this patent is a device for sensing temperatures in which the Sensor is designed in the form of a non-separable, integral component, with “clamping arms” to provide a connection to a workpiece.
5. U.S. Pat. No. 6,558,036—Non-intrusive Temperature Sensor for Measuring Internal Temperature of Fluids Within Pipes.
   The apparatus of this patent is yet another arrangement for sensing temperature within a pipe carrying fluids, in which the apparatus uses an insulative gas within the housing of the Sensor.
6. U.S. Pat. No. 6,814,486—Return Bend Temperature Sensor.
   The apparatus of this patent is yet another solution for curved pipes, in which the inventor relies on thermally conductive clips for additional heat transfer to the Sensor.
7. U.S. Pat. No. 7,100,462—Self Adjusting Sensor Mounting Device.
   The apparatus of this patent tackles the adjustments necessary to affix an essentially flat Sensor to a surface which is “flat in one dimension and flat or curved in a second dimension” (i.e., including pipes and tubes) using a gasket.
8. U.S. Pat. No. 7,748,224—Air-Conditioning Assembly.
   The apparatus of this patent, an entire cooing system, involves at least one component of that system intended to measure temperatures. That component includes an insulator body, a Sensor, and a strap, the insulator body formed with a substantially concave recess.

The inventions disclosed in these patents and appearing in these devices appear to fulfill only some of their respective objectives. As noted above, these objectives include some of the objectives we have discussed herein. The problem of heat transfer to the site of the Sensor is not new, and a number of inventors have attempted to address this problem in a number of ways. The apparatus appearing in these patents, and all other similar devices in use today, do not adequately address the sources of heat at or along a Fluid Line within a System, and are not formed in such a configuration, and of such materials, as to adequately address the problem of heat transfer along a Fluid Line. Such apparatus and devices therefore have not accounted for those temperature reading inaccuracies which cause significant variance from optimal conditions when charging a System. The reason why this is so is that no Sensor apparatus in use today is designed so as to minimize material heat transfer from ambient air, whatever its location, and formed of materials which accomplish the purpose of such design. As a result, while the inventors have attempted to address the problem of heat transfer to the site of the Sensor in a number of ways, these ways, individually and in combination, do not result in isolation of the Sensor sufficiently to read a temperature accurately enough to achieve installation and maintenance of heating and cooling Systems for, or even approaching, optimal efficiency.

### DISCLOSURE OF INVENTION

### Summary of the Invention

The present invention consists of a new design for an Assembly which is employed to measure the temperature of a (generally) cylindrical tube, pipe, or other “line,” within which a heating or cooling fluid flows (a “Fluid Line”). The Assembly design of the present invention incorporates a thermocouple, a thermistor, or other resistance temperature detector (RTDs). Thermocouples, thermistors, and RTDs, which are the electrically active temperature reading elements of Sensors are collectively termed “Contact Temperature Sensors” herein. Contact Temperature Sensors are chosen to read a temperature range, within which the Fluid Line will operate at and around optimal conditions, during installation and maintenance of a System, and for continuous monitoring of a System. As we note herein, our goal is to read the temperature of the fluid contained within, and moving within, a Fluid Line. Reading such temperatures is desirable, and even necessary, in various industrial and scientific applications, but reading such temperatures is particularly necessary to the installation and maintenance of heating, cooling, and refrigeration systems, such as environmental cooling systems.

However, direct reading of the fluid within a Fluid Line is generally not practical, because the fluid within a Fluid Line is generally installed under pressure. Opening a Fluid Line to insert a Sensor is therefore considered undesirable, as sealing such a Fluid Line is difficult and expensive, and may ultimately not be successful. In the present invention, therefore, we choose to read the temperature of a fluid within a Fluid Line from the exterior of the Fluid Line, by placing the Contact Temperature Sensor in direct contact with the Fluid Line. The Contact Temperature Sensor is therefore formed of materials which may be set directly upon, and so be in direct contact with, a heating or cooling Fluid Line. Many designs for a Contact Temperature Sensor having these properties are commercially available. The Contact Temperature Sensor is electrically connected to a Contact Temperature Sensor lead (the “Lead”), by which the electrical signal generated by the Contact Temperature Sensor may be transmitted to a meter which interprets the signal as a measured temperature within the chosen range of the Contact Temperature Sensor.

When the Assembly of the present invention is in operation, the Contact Temperature Sensor resides within a housing which partially surrounds the Contact Temperature Sensor (the “Housing”). More specifically, the Housing is designed to enclose the Contact Temperature Sensor when placed on a Fluid Line, thereby preventing the flow of air (or other fluids) over the Contact Temperature Sensor as it reads a Fluid Line temperature. Accordingly, the Housing is formed to surround the Contact Temperature Sensor on its sides, and cover over the Contact Temperature Sensor on its top. The Housing remains open at its bottom, so that the Contact Temperature Sensor residing within the Housing may rest on the Fluid Line to be measured. The Contact Temperature Sensor Lead, by which the electrical signal generated by the Contact Temperature Sensor may be transmitted to a meter, extends though a channel in the body of the Housing, at a point which is convenient, generally through the top of the Housing. The Housing channel is either preformed or, preferably, created as the material of the Assembly is heated and molded into shape. The Lead may also extend through the body of the Housing at its side if space constraints within a System, particularly surrounding a Fluid Line, make a “low profile” Assembly desirable. In any case, the material of the Housing is formed to close tightly around the Lead, to prevent transmission of air or other fluid between the Lead and the Housing, and from the interior of the Housing to its exterior, or from the exterior of the Housing to its interior.

The design of the Housing, the materials from which it is made, and the means by which the Assembly of the present invention is affixed to a Fluid Line, are all important to accuracy in reading the temperature of a fluid within a Fluid Line. Beginning with the Housing design, the Housing may be generally circular when viewed from the top down, or it may be generally square or rectangular, or of another shape, when so viewed. The Assembly of the present invention may also be tall when viewed from the side, or short in a “low profile” configuration. Whatever its shape when viewed from the top or from the side, the Assembly of the present invention is wide enough to fit over a significant section of the Fluid Line to be measured. The competing factors in determining the size of the Housing include: (i) increased accuracy as a Sensor covers more of the Fluid Line, (ii) decreased effectiveness in keeping the Contact Temperature Sensor insulated from environmental factors as a Sensor increases in size, and (iii) increased cost as a Sensor increases in size.

As we note elsewhere herein, the accuracy of reading the temperatures of a fluid within a Fluid Line by affixing a Sensor to the exterior of such a line is affected by ambient air temperature. This effect arises primarily through two mechanisms:
1. The accuracy of reading the temperature of a fluid within a Fluid Line by affixing a Sensor to the exterior of such a line is affected by ambient air temperature at the site at which the Sensor is affixed to the Fluid Line (that is, directly below the temperature sensing component of a Sensor). Because the Sensor is affixed to the exterior of a Fluid Line, that Sensor may be surrounded in part with ambient air which is warmer or cooler than the exterior surface of the Fluid Line which is being measured (which is generally warmer or cooler than the fluid within the Fluid Line). Such an externally applied Sensor is thereby directly affected, that is, by contact with, both the exterior of the Fluid Line, upon which the Sensor is placed, and the ambient air which may circulate around the Sensor. The result is that the Sensor then “reads” a temperature somewhere between the temperature of the exterior of the Fluid Line and the temperature of such ambient air.
2. The accuracy of reading the temperature of a fluid within a Fluid Line by affixing a Sensor to the exterior of such a line is also affected by ambient air circulating around the Fluid Line at points along the Fluid Line some distance from the site on the Fluid Line at which the Sensor is affixed. Since a Fluid Line is generally formed of a metallic material in tubular form, such a Fluid Line is heated or cooled by such ambient air temperature on its exterior while it is also being heated or cooled by the fluid running within the Fluid Line. Heat is thereby conducted within the material of the Fluid Line from areas of the Fluid Line close to the site at which the Sensor is affixed to the Fluid Line (for a Fluid Line with a cooler fluid within), or away from the Sensor to such areas peripheral areas (for a Fluid Line with a warmer fluid within). The difference between the temperature on the exterior of a Fluid Line, to which a Sensor is affixed, and the temperature of the fluid within that Fluid Line, makes the temperature reading of a Sensor affixed to the exterior of a FL inherently inaccurate. That inaccuracy results in less than optimal installation of cooling and heating systems, and less than optimal maintenance of such systems.

As to that factor in determining the size of the Housing which allows increased accuracy as the Sensor covers more of the Fluid Line, the Housing of the Assembly of the present invention is composed of a flexible, resilient and insulative material. Suitable materials include a material as simple and available as rubber, which has excellent flexibility, resiliency and insulative properties, as it may be easily deformed, returning to its original shape after being deformed, and it is an excellent insulator. Other materials may also be suitable for the Housing of the present invention, however, so long as they are flexible, resilient and insulative. Synthetic rubbers, which are artificial elastomers, are also suitable, as the mechanical (or material) properties of elastomers allow them to undergo much more elastic deformation under stress than most materials and still return to their previous size and shape without permanent deformation. Examples of such synthetic rubbers include, but are not limited to, styrene-butadiene rubbers (SBR), derived from the copolymerization of styrene and 1,3-butadiene, and other synthetic rubbers prepared from isoprene, chloroprene, and isobutylene. These and other monomers can be mixed in various proportions to be copolymerized to produce products with a range of physical, mechanical, and chemical properties, to result in material properties desirable in the formation and operation of the present invention, while exhibiting excellent thermal stability, and compatibility with petroleum products. Rubbers, synthetic rubbers, and other materials suitable for construction of the present invention because they are flexible, resilient and insulative, will be referred to herein as “Rubber.”

With the characteristics of these materials in mind, a Rubber Housing, formed as described herein, addresses the first source of inaccuracy noted above, because the Rubber of the Housing is, in such form, interposed between the Contact Temperature Sensor of the Assembly of the present invention, and exterior or ambient air. As Rubber and other similar materials are highly resistant to the movement of exterior or ambient air, such ambient influences do not directly circulate around the Contact Temperature Sensor. Without such circulation, the ambient influences can have no direct effect on the temperature read by the Contact Temperature Sensor. The externally applied (to the Fluid Line) Contact Temperature Sensor is thereafter no longer affected both by the temperature of the exterior of the Fluid Line, upon which the Contact Temperature Sensor is placed, and by the ambient air which may, absent the flexible, resilient and insulative material of the Housing, circulate around the Contact Temperature Sensor. And as Rubber is highly insulative, heat transfer by conduction and radiation are also minimized. The result is that the Contact Temperature Sensor then may read a temperature closer to the temperature of the exterior of the Fluid Line, and accuracy is increased.

Moreover, a Rubber Housing formed as described herein addresses the first source of inaccuracy noted above in another way, as the Housing, when formed with an interior cavity, allows air within the cavity to approach the temperature of the exterior of the Fluid Line. With such a cavity, the Housing is formed with its top and sidewall in a single unit, with a cavity opening on the bottom of the Housing, and a rim, lip, or edge at the bottom of the sidewall. When the Assembly of the present invention is not in use, such a Housing cavity is open to ambient influences, such as surrounding air or water. However, when the Assembly of the present invention is placed in use by positioning the Housing of the Assembly on a Fluid Line, the air within the cavity directly influences the temperature reading of the Assembly as the air within the Housing directly circulates within the Housing, and around the Contact Temperature Sensor. Again the result is that the Contact Temperature Sensor then may read a temperature closer to the temperature of the exterior of the Fluid Line, and accuracy is increased.

The insulative effect of the Housing may be increased by the addition of a thermally conductive foil, formed within the interior surface of the Housing cavity. Such foil may reflect radiation which may otherwise result in heating the Contact Temperature Sensor of the Assembly. At the same time, the foil creates an environment within the Housing which is more uniform in temperature when the Housing is placed on a Fluid Line. The insulative effect of the Housing is perfected when the Housing is secured to the Fluid Line by extending the Strap (more fully described below) around the Fluid Line, pulling the Strap near its ends away from the Housing to create a tension in the Strap, and securing the ends of the Strap together.

A Housing of Rubber formed as described herein addresses the second source of inaccuracy noted above because the Rubber of the Housing, in such form, occupies a space across the surface of the Fluid Line, or along its length. At the very least, then, the highly resilient and insulative material of the Housing occupies the surface of the Fluid Line immediately adjacent the Contact Temperature Sensor when the Housing is placed on the surface of a Fluid Line, thereby eliminating the movement of exterior or ambient air across such surfaces. The larger the Housing, the better in this regard. As we note herein, a Fluid Line formed of metallic material conducts heat within the material of the Fluid Line from areas of the Fluid Line to the site at which the Contact Temperature Sensor is affixed to the Fluid Line (for a Fluid Line with a cooler fluid within), or away from the Assembly to such areas peripheral areas (for a Fluid Line with a warmer fluid within). However, if the Housing of the Assembly of the present invention is formed to occupy space adjacent the externally applied Contact Temperature Sensor, the Contact Temperature Sensor is less temperature affected by the temperature of ambient air near the site at which the Contact Temperature Sensor is placed. A larger Housing means ambient air is excluded around the Fluid Line adjacent the Contact Temperature Sensor. The Contact Temperature Sensor is therefore directly in contact with, and so directly affected by, only the fluid running within the LF upon which the Contact Temperature Sensor is placed. The ambient air above that adjacent area has been displaced by the material of the Housing formed around the Contact Temperature Sensor. The result is that the Contact Temperature Sensor then may read a temperature closer to the temperature of fluid within the Fluid Line, and accuracy is again increased. And as the area occupied by the Housing of the Assembly of the present invention when in use is increased, so also is the increase in accuracy of the Assembly, as more of the Fluid Line is in direct contact with the fluid within the Fluid Line, without offsetting contact with ambient air on the exterior surface of the Fluid Line opposite that fluid. Accordingly, accuracy of reading is increased in proportion to the size of the Housing as it occupies space around or along the Fluid Line to be measured. This accuracy-increasing effect may be incrementally enhanced by covering the surface of the Fluid Line by the Housing even some distance from the point at which the Contact Temperature Sensor is placed on the surface of the Fluid Line.

A Rubber Housing formed as described herein addresses the second source of inaccuracy noted above in another way, as the Housing, when formed with an interior cavity, allows air within the cavity to approach the temperature of the exterior of the Fluid Line. With such a cavity, the air within the cavity again directly influences the temperature reading of the Assembly as the air within the Housing directly circulates around the Contact Temperature Sensor. Again, the result is that the Contact Temperature Sensor then may read a temperature closer to the temperature of the exterior of the Fluid Line, and accuracy is increased. And, again, the insulative effect of the Housing may be increased by the addition of a thermally conductive foil, formed within the interior surface of the Housing cavity. Such foil may reflect radiation which may result in heating the Contact Temperature Sensor of the Assembly and, at the same time, create an environment within the Housing which is more uniform in temperature when the Housing is placed on a Fluid Line.

The size of the Housing, and particularly its width, is important to the accuracy gained by eliminating direct contact between ambient air and Fluid Line surfaces adjacent to, or even distant from, the Contact Temperature Sensor. Utilizing a larger, wider Housing, such direct contact is eliminated adjacent to the Contact Temperature Sensor, as the bottom face of the Housing, which surrounds the Contact Temperature Sensor in embodiments without a cavity within the Housing, is pressed against the Fluid Line, thereby displacing such ambient air. As the width of the Housing is increased, the direct contact of ambient air with Fluid Line surfaces around the Contact Temperature Sensor is reduced proportionally. With a larger Housing, heat must travel a greater distance between the Contact Temperature Sensor and surfaces of the Fluid Line where ambient air may make contact. While the material of the Fluid Line may still carry heat to or from surfaces in contact with ambient air, the material of the Fluid Line residing under the Housing is not so exposed to such ambient air, but is exposed to the fluid within the Fluid Line. The exterior surface of a Fluid Line, covered by the Housing, may rise or fall in temperature because it is insulated from ambient air, while the interior surface of the Fluid Line, exposed only to the moving fluid of the Fluid Line, will come closer to the temperature of the fluid within the Fluid Line. With such a larger Housing, therefore, the source of (or sink for) heat at the surface of the Fluid Line originates from a greater distance along the surface of the Fluid Line, i.e., outside the periphery of the Housing. The Contact Temperature Sensor, on the other hand resides on the Fluid Line surface at the center of the Housing, relatively far from such source or sink, and it resides only the thickness of the Fluid Line tubing wall from the fluid within the Fluid Line (which temperature is to be measured). The Assembly of the present invention may therefore be designed to increased temperature reading accuracy to meet application requirements.

By designing a cavity within the Housing, further accuracy may be achieved. With such Housing cavity, the temperature within the cavity is determined in large part by the temperature of the exterior surface of the Fluid Line at or adjacent to the Contact Temperature Sensor assuming the absence of ambient air. Since ambient air has been eliminated by interposing the body of the Housing between the surface of the Fluid Line and such ambient air, the surface of the Fluid Line, and the “dead” air within the cavity of the Housing, may come to a temperature close to that of the fluid within the Fluid Line. Once the dead air within the Housing stabilizes at or near the temperature of the fluid within the Fluid Line, that dead air also reaches the surface of the Fluid Line more distant from the Contact Temperature Sensor, thereby “pre-cooling” or “pre-heating” such surfaces, thereby reducing the heating or cooling effect of the source or sink for heat outside the periphery of the Housing.

However, in some applications an insulating plug is desirable to eliminate the dead air within the cavity of the Housing. In such cases, the insulating plug then comprises multiple small dead air spaces. The insulating plug in such cases is formed with a channel, through which the Lead for the Contact Temperature Sensor may run, and the Lead then runs through a channel formed in the Housing, through a second channel of the insulating plug, to connect electrically to the Contact Temperature Sensor. With this arrangement, the Contact Temperature Sensor is centered within the Housing, and pressed against the surface of the Fluid Line by the insulating plug, which provides within the Housing additional insulation against ambient air.

Given just these considerations regarding the size of the Housing of the present invention, an operator using the Assembly of the present invention, generally one installing or maintaining a System, may choose an Assembly having a housing size which is optimal for the use at hand. Thus, for instance, such operator may wish to determine fluid temperature within a Fluid Line of large diameter. Such a Fluid Line will generally be formed with a thicker wall, having greater ability to transfer heat to or from surrounding areas of the Fluid Line, areas which are exposed to ambient air. Under such circumstances, such operator will wish to chose an Assembly having a Housing with “effective” size, designed for optimal temperature reading of such large diameter Fluid Line. Similarly, an operator may be faced with higher ambient temperatures, and choose an Assembly having a Housing with large effective size, to provide greater insulation in such conditions. Or when faced with a Fluid Line of medium size, an operator may choose an Assembly having a Housing with “effective” size, designed for optimal temperature reading of such medium diameter Fluid Line. Or when faced with a Fluid Line of small size, an operator may choose an Assembly having a Housing with “effective” size, designed for optimal temperature reading of such small diameter Fluid Line. Under the circumstances of reading the temperature of a small diameter size Fluid Line, or even in some cases, a medium diameter size Fluid Line, the Assembly of the present invention may be formed to completely encircle such a Fluid Line, thereby preventing contact between ambient air and the surface of such a Fluid Line at some distance from the point of contact between the Contact Temperature Sensor and the surface of the Fluid Line. The size and shape of the Housing of the Assembly of the present invention may be fairly described as “effective size” and “effective shape,” so long as the Assembly Housing may be affixed to a Fluid Line to exclude ambient influences as described herein. Accordingly, “effective size” and “effective shape” will also depend on how the Housing of the Assembly of the present invention is affixed to a Fluid Line, a subject to which we now turn.

The Housing of the present invention, when in use, is affixed to a Fluid Line by a strap, which is designed to completely encircle the Fluid Line (the “Strap”). The Strap may be attached, in one or two pieces, to the Housing by suitable means, or the Strap may be formed as a single unit with the Housing, and of the same material. In any case, the Strap is also flexible and resilient, so that it may be stretched and, when the force by which it is stretched is removed, the Strap returns to its original length and shape. In use, an operator may select an Assembly having a Housing of effective size and shape, place the Housing on the surface of the Fluid Line to be measured, encircle the Fluid Line with the Strap, stretch the strap slightly to affix the Housing of the Assembly against the surface of the Fluid Line, and fasten the two ends of the Strap by suitable means. Once in such position on the surface of the Fluid Line, the Housing of the Assembly is held securely in place by the tension created by the Strap as it seeks to return to its original length (but cannot because the ends of the Strap are held by the suitable fastening means).

Truly insulative effect is achieved through the design of the Assembly as set forth herein, in light of the Rubber from which the Assembly is composed. Since the Strap and the Housing are each composed of such Rubber, and since they are formed in a unitary body (or securely affixed to one another) in a linear arrangement, this design using these materials allows an operator to deform the Housing as that operator secures the Assembly in place on the surface of a Fluid Line. The deformation of the Housing results from the tension created by the operator, which tension the Strap maintains once the Assembly is position on a Fluid Line, and the ends of the Strap are joined. With such tension maintained, the rim, lip or edge of the Housing is deformed right along with the Housing top and Housing sidewall, and the sidewall is therefore bent out of resting shape, and pulled or pushed down onto the surface of the Fluid Line to be measured. In such position, the sidewall is compressed against the surface of the Fluid Line, thereby creating a seal against entry of ambient air into the cavity of the Housing as the side wall conforms to the shape of the Fluid Line. In embodiments of the present invention without a cavity, the entire Housing is pulled down against the Fluid Line to be measured, and deformed and held in place so that the edge at the periphery of the Housing conform to the shape of the Fluid Line.

In one embodiment of the Assembly of the present invention, the Strap is formed with slits or holes (collectively “slits”) along its length on one side of the Housing. The Strap is at the same time formed with a fastening means, generally a wide or narrow hook, on the opposite side of the Housing, or with an adjustment prong on that opposite side of the Housing (collectively “fastening means”), either of which may be inserted into their corresponding slit or hole at the other end of the Strap once the two ends of the Strap are wrapped around a Fluid Line and joined. Once the Housing of the Assembly is in the correct position, the distal ends of the Strap are stretched an appropriate amount, thereby pressing the lip of the Housing against the Fluid Line as the Housing deforms, affixing the Housing in place, and the distal ends of the Strap are joined using the slits and hook, or using the holes and prong. By inserting the hook or prong in an appropriate slit or hole, the Strap may be tensioned so as to keep the Housing in the correct position on the Fluid Line. Since the slits or holes are formed along the length of one side of the Strap, the Strap may be used to affix the Housing of the Assembly to a Fluid Line of large diameter, small diameter, or somewhere between large and small diameter. Other means (e.g., “Velcro”) may be used to secure the distal ends of the Strap to each other once the Housing is in place on a Fluid Line.

The flexibility and resiliency of the Housing and Strap of the present invention is of critical importance to fastening the Assembly of the present invention to a cylindrical Fluid Line. These properties come into play in a number of ways. Firstly, the flexibility of the Housing of Assembly allows the Housing to be formed with a substantially flat lower surface which, because the material of the Housing is flexible and resilient, will fully engage the cylindrical surface of the Fluid Line. The notion here is that the lower surface of the Housing will deform because it is flexible, thereby conforming to the cylindrical Fluid Line shape when the Strap is tensioned and its ends secured to one another. Once in its deformed shape, the Housing also pushes its entire lower surface against the surface of the Fluid Line, thereby sealing the lower surface of the Housing, and the cavity within the Housing, against infusion of ambient air. Thus, in use the entire Housing may be bent, or just the lower surface or edges of the Housing may be bent, along with any insulation or metal foil contained within, so that the bottom face and edge of the Housing, or the bottom rim, lip or edge of the sidewall of the Housing, sit tightly flush against the surface of the Fluid Line, whether the Fluid Line is curved or flat, and regardless of the degree of curvature. The sealing effect is greatest, and durability is enhanced, when the Assembly of the present invention is formed of a single, unitary body, composed of and molded from Rubber, having flexible, resilient and insulative material properties (rubber, synthetic rubbers, or other suitable materials).

As we note above, a Sensor generally reads less accurately as its size increases. As the size of a Sensor increases, so also does the surface over which ambient air may flow to warm or cool the Sensor, thereby producing in a Sensor a temperature somewhere between ambient and the object to be measured. Also, as the size of a Sensor increases, so also does the difficulty in isolating the Sensor from ambient air, which may leak into the area of the Sensor, perhaps even coming directly in contact with the thermocouple or thermister used to read the temperature of the Fluid Line. These difficulties are minimized with the Assembly of the present invention, and particularly minimized when choosing an Assembly of size appropriate to the temperature reading task at hand. And, while the Assembly of the present invention is quite usable as a device for temporary attachment to a Fluid Line, in installation or maintenance of a System, for instance, the present invention is also sufficiently durable to be attached to a Fluid Line to permanently monitor the temperature of that Fluid Line, and therefore the condition of the System which includes that Fluid Line.

The more important features of the invention have thus been outlined, rather broadly, so that the detailed description thereof that follows may be better understood, and in order that the present contribution to the art may be better appreciated. Additional features of specific embodiments of the invention will be described below. However, before explaining preferred embodiments of the invention in detail, it may be noted briefly that the present invention substantially departs from pre-existing apparatus and methods of the prior art, and in so doing provides the user with the highly desirable ability to read the temperature of Fluid Lines with increased accuracy, an accuracy which is close to reading the temperature of a fluid within a Fluid Line. With the changes in design and materials of manufacture away from designs and materials commonly utilized to manufacture Sensors for Systems, including heating and cooling Systems, The Assembly of the present invention allows a heating or cooling system to be “tuned” during installation or maintenance to maximize efficiency of a System, thereby increasing the effectiveness of such systems, while reducing overall energy costs.

### OBJECTS OF THE INVENTION

A principal object of the present invention is to allow an operator to read the temperature of a fluid within a Fluid Line to a high degree of accuracy.

A further principal object of the present invention is to provide a means to read the temperature of a Fluid Line without significant inaccuracy introduced by environmental factors such as ambient air temperature.

A further principal object of the present invention is to provide an operator with a tool for temporarily reading the surface temperature of a Fluid Line during installation or maintenance of a System, such as a heating or cooling (“air conditioning”) system.

A further principal object of the present invention is to provide an operator with a tool for quickly and easily reading the surface temperatures of a number of Fluid Lines of a heating or cooling system during installation or maintenance, because the tool may be applied to and removed from such Fluid Lines quickly and easily.

A further principal object of the present invention is to provide an operator with a tool for inexpensively reading the surface temperatures of a number of Fluid Lines of a heating or cooling system during installation or maintenance, because the tool may be used to read temperatures in multiple units, for simultaneous reading of multiple Fluid Lines in such Systems.

### BRIEF DESCRIPTION OF DRAWINGS

The accompanying drawings, which are incorporated in and constitute a part of this specification, illustrate two preferred embodiments of the present invention, and such drawings, together with the description set forth herein, serve to explain the principles of the invention.

FIG. 1 is a top down view drawing of a first embodiment of the Assembly of the present invention.

FIG. 2 is a perspective view drawing of the Assembly shown in FIG. 1, in which appears the top, one side, and one end.

FIG. 3 is a perspective view drawing of the Assembly shown in FIG. 1, in which appears the bottom, and the one side and one end appearing in FIG. 2.

FIG. 4 is a top down view drawing of the Assembly shown in FIG. 1, in which the Assembly has be affixed to a Fluid Line.

FIG. 5 is a partially disassembled perspective view drawing of a second embodiment of the Assembly of the present invention, in which appears the top, one side, and one end, an insulating plug, and a Contact Temperature Sensor with Lead.

### DETAILED DESCRIPTION OF A FIRST PREFERRED EMBODIMENT

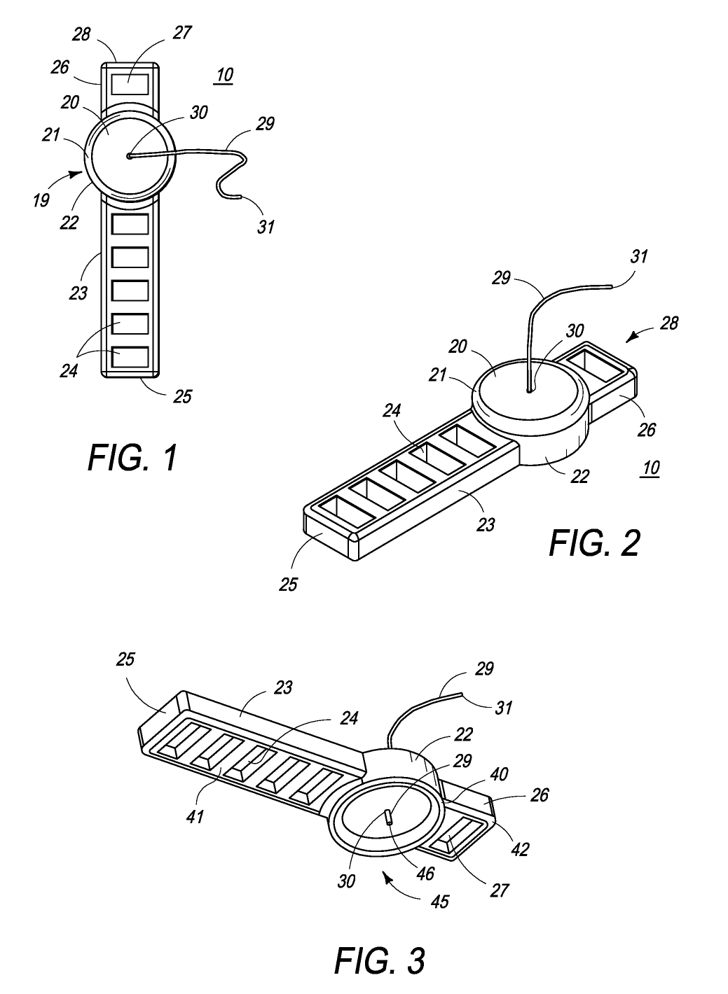

Referring initially to FIG. 1, a first embodiment of the Assembly of the present invention 10 is shown in top down view, i.e. viewed from above the Assembly. In FIG. 1, Housing 19 may be seen, having generally circular form, with shoulders 21 extending to Housing sidewall 22, and Housing top 20. Strap first part 23, with slits 24 formed therein, and strap first part end 25, may also be seen extending from Housing sidewall 22 on one side of Housing 19. Strap second part 26, with at least one slit 27 formed therein, and strap second part end 28, may also be seen extending from Housing sidewall 22 on the opposite side of Housing 19 from strap first part 23. The at least one slit 27 may be fitted with a hook (not shown) or adjustment prong (not shown), or such hook or adjustment prong (not shown) may be formed integrally with strap second part 26, typically at or near its strap second part end 28. Contact Temperature Sensor Lead 29 may be seen emanating from a channel 30 at the center of the top of Housing 19, which Lead 29 may be electrically connected to Contact Temperature Sensor (not shown), as it resides within Housing 19 and, at the other end 31 of Lead 29, a meter (not shown) which interprets the signal of the Contact Temperature Sensor as a measured temperature within its chosen temperature range.

Housing 19 is designed to enclose the Contact Temperature Sensor, thereby preventing the flow of air over the Contact Temperature Sensor as Assembly 10 is placed on a Fluid Line (not shown). Accordingly, Housing 19 is formed to surround the Contact Temperature Sensor on its sides with Housing sidewall 22, and cover over the Contact Temperature Sensor on its top with Housing top 20. Housing 19 is open at its bottom, so that the Contact Temperature Sensor residing within the Housing may rest on the Fluid Line for the temperature to be measured. Contact Temperature Sensor Lead 29, by which the electrical signal generated by the Contact Temperature Sensor may be transmitted to a meter, extends though channel 30 in Housing 19, at a point which is convenient, generally through Housing top 20 near its center. As noted previously herein, Housing 19, including Housing top 20 and Housing sidewall 22, Strap first part 23, and Strap second part 26, are all composed of a flexible, resilient and insulative material, such as rubber, synthetic rubbers, or other suitable materials having these properties.

In FIG. 2, the Assembly of the present invention 10 is shown in perspective view, with Assembly top, one side, and one end apparent. Housing top 20 and Housing sidewall 22 each appear, with Housing shoulders 21 extending from Housing top 20 to Housing sidewall 22. Strap first part 23, with slits 24 formed therein, and strap first part end 25, may also be seen extending from Housing sidewall 22 on one side of Housing 19, while Strap second part 26, with at least one slit 27 formed therein, and strap second part end 28, may also be seen extending from Housing sidewall 22 on the opposite side of Housing 19 from strap first part 23. Contact Temperature Sensor Lead 29 may again be seen emanating from channel 30 near the center of top 20 of Housing 19, which Lead 29 may be electrically connected to Contact Temperature Sensor (not shown), as it resides within Housing 19 and, at the other end 31 of Lead 29, a meter (not shown) which interprets the signal of the Contact Temperature Sensor as a measured temperature within its chosen temperature range.

Turning to FIG. 3, Assembly 10 of the present invention is shown in perspective view, with Assembly bottom, one side, and one end apparent. Housing rim, lip or edge 40 may be seen at bottom of sidewall 22, along with Strap first part 23, with slits 24 formed therein, and strap first part end 25, extending from Housing sidewall 22 on one side of Housing 19. Strap second part 26, with at least one slit 27 formed therein, may also be seen extending from Housing sidewall 22 on the opposite side of Housing 19 from strap first part 23. As we are viewing Assembly 10 of the present invention from the bottom in this perspective view, we also see rim, lip or edge 40 at the bottom of sidewall 22, as well as the smooth bottom face 41 of Strap first part 23, and the smooth bottom face 42 of Strap second part 26. In this embodiment, Housing lip 40 may be deformed, right along with the Housing top 20 and Housing sidewall 22, as an operator secures Assembly 10 in place on the surface of a Fluid Line (not shown), pulls the ends of Strap first part 23 and Strap second part 26 to create tension, and hooks or otherwise secures strap second part end 28 to one of slits 24 formed in Strap first part 23. We may appreciate that a tight seal is thereby formed between the exterior surface of a Fluid Line and rim, lip or edge 40 at the bottom of sidewall 22, as sidewall 22 is thereby bent out of resting shape, and pulled or pushed down onto the surface of the Fluid Line to be measured. In such position, sidewall 22 is compressed against the surface of the Fluid Line, thereby creating a seal against entry of ambient air into cavity 45 of Housing 19 as side wall 22 conforms to the shape of the Fluid Line. The Contact Temperature Sensor Lead 29 may again be seen emanating from channel 30 near the center of top 20 of Housing 19, which Lead 29 may be electrically connected at its first end 31 to a meter (not shown). Within Housing cavity 45, Contact Temperature Sensor 46 may be seen attached to the second end of Lead 29 which enters housing 19 through channel 30.

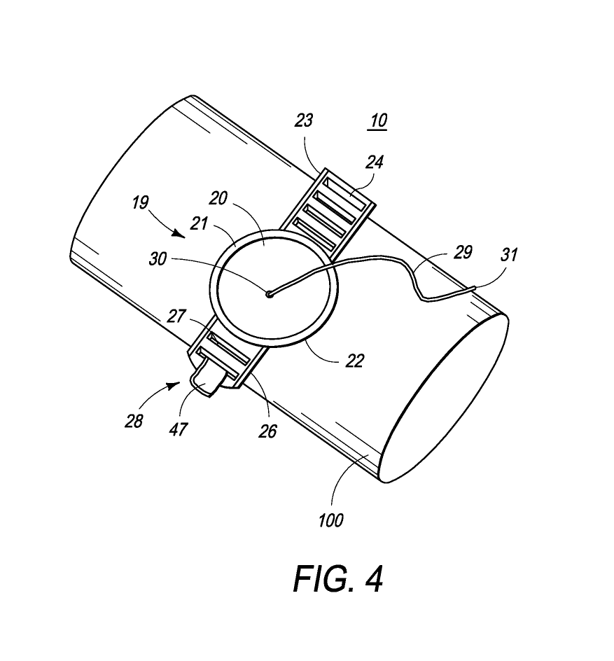

In FIG. 4, the first embodiment of the Assembly of the present invention 10, as shown in FIG. 1, is again shown in substantially top down view. However, in FIG. 4, Housing 19 of Assembly 10 has been positioned on a (coolant tube) Fluid Line 100, and Strap first part 23, with slits 24 formed therein, extending from Housing sidewall 22 on one side of Housing 19, has been partially wrapped around Fluid Line 100. Strap second part 26, with at least one slit 27 formed therein, and strap second part end 28, may also be seen extending from Housing sidewall 22 on the opposite side of Housing 19 from strap first part 23. In FIG. 4, Strap first part 23 and Strap second part 26 have been tensioned by an operator as described herein, and hook 47 has been inserted into one of slits 24 (not shown) of Strap first part 23, and at least one slit 27 of Strap second part 26, thereby securing Assembly 10 to coolant tube 100. Also seen in FIG. 4 are shoulders 21 extending to Housing sidewall 22, and Housing top 20, and Contact Temperature Sensor Lead 29 emanating from channel 30 at the center of the top 20 of Housing 19.

As noted previously herein, Housing 19, including Housing top 20 and Housing sidewall 22, Strap first part 23, and Strap second part 26, are all composed of a flexible, resilient and insulative material, such as rubber, synthetic rubbers, or other suitable materials having these properties. Accordingly, insulative effect is achieved when Assembly 10 is affixed to Fluid Line 100 as seen in FIG. 4. Strap first part 23, Strap second part 26, and Housing 19, each composed of such materials and formed in a unitary body (or securely affixed to one another) in a linear arrangement, each deform as the operator secures Assembly 10 in place on the surface of Fluid Line 100 as shown in FIG. 4. The deformation of Housing 19 results from the tension created by the operator, which tension Strap first part 23 and Strap second part 26 maintain once Assembly 10 is positioned on Fluid Line 100, and end 25 (not shown) of Strap first part 23 is joined with end 28 of strap second part 26. With such tension maintained, the rim, lip or edge 40 (not shown in FIG. 4.) of Housing 19 is deformed with Housing top 20 and Housing sidewall 22, and sidewall 22 is therefore bent out of resting shape, and pulled or pushed down onto the surface of Fluid Line 100. In such position, sidewall 22 is compressed against the surface of Fluid Line 100, thereby creating a seal against entry of ambient air into cavity (not shown) of Housing 19 as sidewall 22 conforms to the shape of Fluid Line 100. In embodiments of the present invention without a cavity, entire Housing 19 is pulled down against Fluid Line 100, and deformed and held in place, so that the edge at the periphery of Housing 19 conforms to the shape of Fluid Line 100.

### DETAILED DESCRIPTION OF A SECOND PREFERRED EMBODIMENT

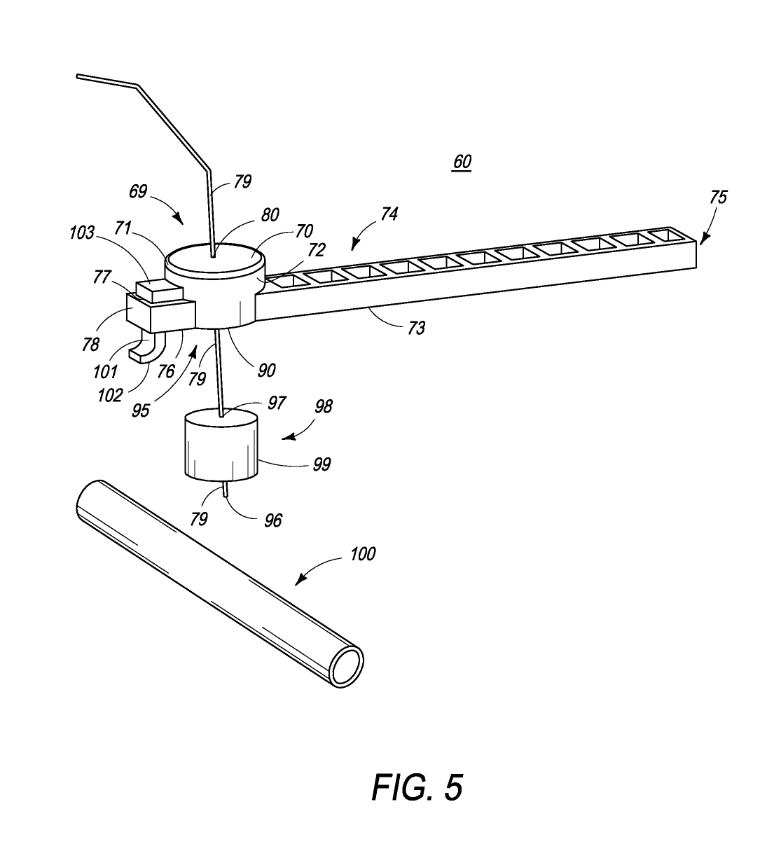

Turning now to FIG. 5, a second embodiment of the Assembly 60 of the present invention is shown in partially disassembled perspective view. In FIG. 5, Housing 69 may be seen, having generally circular form, with shoulders 71 extending to Housing sidewall 72, and Housing top 70. Strap first part 73, with slits 74 formed therein, and strap first part end 75, may also be seen extending from Housing sidewall 72 on one side of Housing 69. Strap second part 76, with at least one slit 77 formed therein, and strap second part end 78, may also be seen extending from Housing sidewall 72 on the opposite side of Housing 69 from strap first part 73. The at least one slit 77 has been fitted with hook 101 near strap second part end 78, and hook end 102 may be seen extending for engagement with one of slits 74, while hook base 103 may be seen anchoring hook 101 through slit 77. Contact Temperature Sensor Lead 79 may be seen emanating from channel 80 at the center of Housing 69 top 70. Lead 79 is electrically connected to Contact Temperature Sensor 96.

Continuing with FIG. 5, Housing 69 is designed to enclose Contact Temperature Sensor 96, thereby preventing the flow of air over Contact Temperature Sensor 69 as Assembly 60 is placed on Fluid Line 100. Accordingly, Housing 69 is formed to surround Contact Temperature Sensor 96 on its sides with Housing sidewall 72, and cover over Contact Temperature Sensor 96 on its top with Housing top 70. Housing 69 is open at its bottom, so that Contact Temperature Sensor 96 residing within the Housing may rest on Fluid Line 100 for accurate reading of the temperature to be measured. Contact Temperature Sensor Lead 79, by which the electrical signal generated by Contact Temperature Sensor 96 may be transmitted to a meter (not shown), extends though channel 80 in Housing 69, at a point which is convenient, generally through Housing top 70 near its center. As noted previously herein, Housing 69, including Housing top 70 and Housing sidewall 72, Strap first part 73, and Strap second part 76, are all composed of a flexible, resilient and insulative material, such as rubber, synthetic rubbers, or other suitable materials having these properties.

FIG. 5. also shows insulating plug 98, which may be used to eliminate dead air within cavity 95 of Housing 69. In this embodiment, insulating plug 98 comprises an insulative material which captures multiple small dead air spaces. Insulating plug 98 in such cases is formed with channel 97, through which Lead 79 for Contact Temperature Sensor 96 may run. When in operation, then, Lead 79 runs through channel 80 formed in Housing 69, and through second channel 97 of insulating plug 98, to connect electrically to Contact Temperature Sensor 96 to a meter (not shown). With this arrangement, Contact Temperature Sensor 96 is centered within Housing 69, and centered within insulating plug 98, and pressed against the surface of Fluid Line 100 (once Assembly 60 is deployed) by insulating plug 98. Insulating plug 98 provides additional insulation against ambient air within Housing 69, and pressure to hold Contact Temperature Sensor 96 against Fluid Line 100 for accurate temperature measurement. The insulative effect of Housing 69 may be further enhanced by the addition of thermally conductive foil 99, which may be formed within the interior surface of Housing cavity 95, or formed over insulating plug 98 as shown in FIG. 5.

Other embodiments will be apparent to those skilled in the art from consideration of the specification and practice of the invention disclosed herein. It is intended that the specification and examples be considered as exemplary only, with a true scope of the invention being indicated by the following claims and equivalents.

What is claimed is:

1. A temperature sensor assembly comprising:
a housing, formed of flexible, resilient, and insulative material, having a top side, a bottom side, at least one sidewall extending between the top side and the bottom side, and a channel extending through the housing;
a strap first part, formed of flexible, resilient, and insulative material, having slits formed therein, with a strap first part distal end, extending from the exterior of the housing sidewall on one side of the housing;
a strap second part, formed of flexible, resilient, and insulative material, having a fastening means, with a strap second part distal end, extending from the exterior of the housing sidewall on the opposite side of the housing from strap first part;
a contact temperature sensor, positioned near the bottom side of the housing; and
an electrical lead, connected to the contact temperature sensor, and extending through the housing channel to the exterior of the housing, for connection to an electrical meter;
whereby the temperature sensor assembly may be positioned on a fluid line, the distal ends of the strap first part and strap second part stretched an appropriate amount, thereby pressing the bottom side of the housing and the contact temperature sensor against the fluid line as the housing deforms, and tensioning the strap first part and the strap second part so as to keep the housing in the correct position on the fluid line, and the distal ends of the strap first part and the strap second part joined by insertion of the strap second part fastening means into the slits of the strap first part, so that the temperature on the exterior of the fluid line may thereby be determined.

2. The temperature sensor assembly of claim 1, in which the housing is generally circular in shape when viewed from the housing top side.

3. The temperature sensor assembly of claim 1, in which the slits of the strap first part are formed as a series of generally circular holes, and the fastening means of the strap second part is an adjustment prong.

4. The temperature sensor assembly of claim 3, in which the housing is generally circular in shape when viewed from the housing top side.

5. The temperature sensor assembly of claim 2, in which the slits of the strap first part are formed as a series of generally circular holes, and the fastening means of the strap second part is an adjustment prong.

6. A temperature sensor assembly comprising:
a housing, formed of flexible, resilient, and insulative material, having a top side, a bottom side, at least one sidewall extending between the top side and the bottom side, a cavity formed in the bottom side, the cavity forming a lip around the exterior edge of the sidewall, and a channel extending through the housing;
a strap first part, formed of flexible, resilient, and insulative material, having slits formed therein, with a strap first part distal end, extending from the exterior of the housing sidewall on one side of the housing;
a strap second part, formed of flexible, resilient, and insulative material, having a fastening means, with a strap second part distal end, extending from the exterior of the housing sidewall on the opposite side of the housing from strap first part;
a contact temperature sensor, positioned near the bottom side of the housing, and within the cavity of the housing; and
an electrical lead, connected to the contact temperature sensor, and extending through the housing channel to the exterior of the housing, for connection to an electrical meter;
whereby the temperature sensor assembly may be positioned on a fluid line, the distal ends of the strap first part and strap second part stretched an appropriate amount, thereby pressing the contact temperature sensor within the housing cavity against the fluid line as the sidewall lip deforms, and tensioning the strap first part and the strap second part so as to keep the housing in the correct position on the fluid line, and the distal ends of the strap first part and the strap second part joined by insertion of the strap second part fastening means into the slits of the strap first part, so that the temperature on the exterior of the fluid line may thereby be determined.

7. The temperature sensor assembly of claim 6, in which the housing is generally circular in shape when viewed from the housing top side.

8. The temperature sensor assembly of claim 6, in which the slits of the strap first part are formed as a series of generally circular holes, and the fastening means of the strap second part is an adjustment prong.

9. The temperature sensor assembly of claim 8, in which the housing is generally circular in shape when viewed from the housing top side.

10. The temperature sensor assembly of claim 7, in which the slits of the strap first part are formed as a series of generally circular holes, and the fastening means of the strap second part is an adjustment prong.

11. The temperature sensor assembly of claim 6, further comprising an insulating plug, with a top, a bottom, and a sidewall, formed to fit snugly within the cavity of the housing, wherein the contact temperature sensor is positioned neat the bottom of the insulating plug.

12. The temperature sensor assembly of claim 11, in which the housing is generally circular in shape when viewed from the housing top side.

13. The temperature sensor assembly of claim 11, in which the slits of the strap first part are formed as a series of generally circular holes, and the fastening means of the strap second part is an adjustment prong.

14. The temperature sensor assembly of claim 14, in which the housing is generally circular in shape when viewed from the housing top side.

15. The temperature sensor assembly of claim 15, in which the slits of the strap first part are formed as a series of generally circular holes, and the fastening means of the strap second part is an adjustment prong.

16. The temperature sensor assembly of claim 11, further comprising an foil, formed around the insulating plug.

17. The temperature sensor assembly of claim 16, in which the housing is generally circular in shape when viewed from the housing top side.

18. The temperature sensor assembly of claim 16, in which the slits of the strap first part are formed as a series of generally circular holes, and the fastening means of the strap second part is an adjustment prong.

19. The temperature sensor assembly of claim 18, in which the housing is generally circular in shape when viewed from the housing top side.

20. The temperature sensor assembly of claim 17, in which the slits of the strap first part are formed as a series of generally circular holes, and the fastening means of the strap second part is an adjustment prong.
